(19) United States
(12) Patent Application Publication
(10) Pub. No.: US 2002/0113667 A1
(43) Pub. Date: Aug. 22, 2002

(54) Directional coupler

(76) Inventors: Yukihiro Tahara, Tokyo (JP); Hideyuki Ohhashi, Tokyo (JP); Moriyasu Miyazaki, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 10/048,922

(22) PCT Filed: Jan. 24, 2001
(86) PCT No.: PCT/JP01/00433

(30) Foreign Application Priority Data
Jun. 6, 2000 (JP) 2000-174287

(51) Int. Cl. H01P 5/18

(52) U.S. Cl. 333/116

(57) ABSTRACT

Capacitors 8, each of which is connected from a position between each of input/output terminals 5a, 5b, 5c, 5d and a coupled line 6 to an ground conductor pattern 7, are provided.

### TECHNICAL FIELD

The present invention relates to a directional coupler for coupling a high frequency signal, which is inputted into a primary line, to a subsidiary line by means of electromagnetic coupling of the primary line and the subsidiary line, which are formed on a dielectric substrate.

### BACKGROUND ART

FIG. 1 is a diagram illustrating a configuration of a conventional directional coupler, which was disclosed in JP-B No. 03-73164 for example. In addition, FIG. 2 is a diagram illustrating a cross section of the directional coupler taken along a line A-A′ shown in FIG. 1.

In FIGS. 1 and 2, a reference numeral 101 is a dielectric substrate having two formation surfaces; reference numerals 102 and 103 are a first inner conductor and a second inner conductor respectively; reference numerals 102a, 102b, 103a, and 103b are strip conductor patterns; a reference numeral 104 represents outer conductors; reference numerals 105a and 105b are input/output terminals of the first inner conductor 102; reference numerals 105c and 105d are input/output terminals of the second inner conductor 103; and a reference numeral 106 is a coupled line.

A pair of the strip conductor patterns 102a and 102b is kept in the same potential and constitutes the first inner conductor 102. In addition, a pair of the strip conductor patterns 103a and 103b is kept in the same potential and constitutes the second inner conductor 103. The strip conductor patterns 102a and 102b are formed on both formation surfaces of the dielectric substrate 101 so that they sandwich the dielectric substrate 101. The strip conductor patterns 103a and 103b are also formed on both formation surfaces of the dielectric substrate 101 so that they sandwich the dielectric substrate 101. The first inner conductor 102 and the second inner conductor 103 are adjacent to each other so as to be coupled electromagnetically in the coupled line 106. A length of the coupled line 106 is about ¼ of a wavelength at a desired frequency.

In addition, the outer conductors 104 are placed in parallel at a predetermined distance so as to sandwich the first inner conductor 102, the second inner conductor 103, and the dielectric substrate 101.

When a high frequency signal is inputted from the input/output terminal 105a of the directional coupler, the high frequency signal propagates through the first inner conductor 102, and then couples electromagnetically to the second inner conductor 103 in the coupled line 106. On the assumption that a length of the coupled line 106 is ¼ of a wavelength in an even mode (a mode for a case in which two electromagnetically coupled lines are excited at in-phase equal amplitude) and in an odd mode (a mode for a case in which two electromagnetically coupled lines are excited at out-of-phase equal amplitude), a coupled high frequency signal has directivity. Therefore, the coupled high frequency signal does not appear in the input/output terminal 105d, but is taken from the input/output terminal 105c.

Because the conventional directional coupler is configured as described above, there is the following problem: a wavelength shortening rate in the even mode is different from that in the odd mode, which causes difference in phase velocity between the modes, resulting in characteristic degradation of the directional coupler.

The problem will be described more specifically.

FIG. 3 illustrates electric field distribution of the directional coupler shown in FIG. 2; and FIGS. 3(a) and 3(b) are a diagram in the even mode and a diagram in the odd mode respectively. Arrows in the diagrams represent electric fields.

As shown in FIGS. 3(a) and 3(b), in the even mode, electric fields hardly exist inside the dielectric substrate 101. On the other hand, in the odd mode, electric fields exist inside the dielectric substrate 101. Because of it, a wavelength shortening rate in the odd mode becomes higher than that in the even mode, which causes difference in phase velocity between the modes. This results in characteristic degradation in directivity, reflection, and the like, of the directional coupler. In other words, the high frequency signal, which has been inputted from the input/output terminal 105a, will be returned to the input/output terminal 105a by reflection; and the coupled high frequency signal will appear in both of the input/output terminals 105c and 105d.

The present invention has been made in order to solve the problem described above, and aims to configure a directional coupler that achieves good directivity and reflection characteristics by compensating for the difference in phase velocity between the even mode and the odd mode, which is caused by difference in the wavelength shortening rate.

### DISCLOSURE OF INVENTION

A directional coupler according to the present invention is configured to have a reactive element that is mounted on a primary line and a subsidiary line, and that compensates for a reactive component equivalently possessed by a coupled line.

This produces the following effects: compensation for difference in phase velocity between the even mode and the odd mode becomes possible, which enables us to configure a directional coupler that has good characteristics such as directivity and reflection.

A directional coupler according to the present invention is configured to have a capacitive element that is mounted on a primary line and a subsidiary line, and that compensates for a parallel capacitive component equivalently possessed by the coupled line.

This produces the following effects: compensation for difference in phase velocity between the even mode and the odd mode becomes possible, which enables us to configure a directional coupler that has good characteristics such as directivity and reflection.

A directional coupler according to the present invention is configured to use a capacitor, which is connected from a position between the input/output terminal and the coupled line to the ground, as a capacitive element.

This produces the following effects: compensation for difference in phase velocity between the even mode and the odd mode becomes possible, which enables us to configure a directional coupler that has good characteristics such as directivity and reflection.

A directional coupler according to the present invention is configured to use an open stub, which is mounted between the input/output terminal and the coupled line, as a capacitive element.

This produces the following effects: work such as soldering becomes unnecessary, which enables us to produce the directional coupler easily; and at the same time, formation of the ground conductor pattern also becomes unnecessary, which excludes influence of the ground conductor pattern in close proximity to the strip conductor pattern on the characteristics of the directional coupler.

A directional coupler according to the present invention is configured to use a low impedance line, which is provided between the input/output terminal and the coupled line, as a capacitive element.

This produces the following effects: providing a capacitor and an open stub becomes unnecessary, which enables a reduction in a loss of the directional coupler.

A directional coupler according to the present invention is so devised that the primary line and the subsidiary line have an intersection area where propagating directions of a high frequency signal intersect at the center of the coupled line when projecting the primary line and the subsidiary line from a normal line direction of the formation surface to a plane parallel to the abovementioned formation surface.

This produces the following effects: even if mutual relative positions of the primary line and the subsidiary line deviate to a direction parallel to the dielectric substrate and at the same time the mutual relative positions deviate to a direction orthogonal to a propagating direction of the high frequency signal in the coupled line, a deviation in a degree of coupling can be reduced, which enables us to produce the directional coupler easily.

A directional coupler according to the present invention is so devised that the primary line and the subsidiary line have an intersection area where propagating directions of a high frequency signal intersect at the center of the coupled line when projecting the primary line and the subsidiary line from a normal line direction of the formation surface to a plane parallel to the above-mentioned formation surface.

This produces the following effects: even if mutual relative positions of the primary line and the subsidiary line deviate to a direction parallel to the dielectric substrate and at the same time the mutual relative positions deviate to a direction orthogonal to a propagating direction of the high frequency signal in the coupled line, a deviation in a degree of coupling can be reduced, which enables us to produce the directional coupler easily.

A directional coupler according to the present invention is so devised that the primary line and the subsidiary line have an intersection area where propagating directions of a high frequency signal intersect at the center of the coupled line when projecting the primary line and the subsidiary line from a normal line direction of the formation surface to a plane parallel to the above-mentioned formation surface.

This produces the following effects: even if mutual relative positions of the primary line and the subsidiary line deviate to a direction parallel to the dielectric substrate and at the same time the mutual relative positions deviate to a direction orthogonal to a propagating direction of the high frequency signal in the coupled line, a deviation in a degree of coupling can be reduced, which enables us to produce the directional coupler easily.

A directional coupler according to the present invention is so devised that the primary line and the subsidiary line have an intersection area where propagating directions of a high frequency signal intersect at the center of the coupled line when projecting the primary line and the subsidiary line from a normal line direction of the formation surface to a plane parallel to the above-mentioned formation surface.

This produces the following effects: even if mutual relative positions of the primary line and the subsidiary line deviate to a direction parallel to the dielectric substrate and at the same time the mutual relative positions deviate to a direction orthogonal to a propagating direction of the high frequency signal in the coupled line, a deviation in a degree of coupling can be reduced, which enables us to produce the directional coupler easily.

A directional coupler according to the present invention is devised in the following manner: a primary line is provided by the first strip conductor pattern that is formed on one formation surface of a dielectric substrate; a subsidiary line is provided by the second strip conductor pattern that is formed in the other formation surface of the dielectric substrate, which is different from said one formation surface of the dielectric substrate where the first strip conductor pattern is formed; and said directional coupler comprises ground conductors, which are placed at a predetermined distance so as to sandwich the dielectric substrate where a pair of the strip conductor patterns are formed.

This produces the following effects: a directional coupler of a suspended strip line, which has good characteristics such as directivity and reflection, can be configured.

A directional coupler according to the present invention is devised in the following manner: a primary line is provided by the first strip conductor pattern that is formed on one formation surface of a dielectric substrate; a subsidiary line is provided by the second strip conductor pattern that is formed in the other formation surface of the dielectric substrate, which is different from said one formation surface of the dielectric substrate where the first strip conductor pattern is formed; and said directional coupler comprises ground conductors, which are placed at a predetermined distance so as to sandwich the dielectric substrate where a pair of the strip conductor patterns are formed.

This produces the following effects: a directional coupler of a suspended strip line, which has good characteristics such as directivity and reflection, can be configured.

A directional coupler according to the present invention is devised in the following manner: a primary line is provided by the first strip conductor pattern that is formed on one formation surface of a dielectric substrate; a subsidiary line is provided by the second strip conductor pattern that is formed in the other formation surface of the dielectric substrate, which is different from said one formation surface of the dielectric substrate where the first strip conductor pattern is formed; and said directional coupler comprises ground conductors, which are placed at a predetermined distance so as to sandwich the dielectric substrate where a pair of the strip conductor patterns are formed.

This produces the following effects: a directional coupler of a suspended strip line, which has good characteristics such as directivity and reflection, can be configured.

A directional coupler according to the present invention is devised in the following manner: a primary line is provided by the first strip conductor pattern that is formed on one formation surface of a dielectric substrate; a subsidiary line is provided by the second strip conductor pattern that is formed in the other formation surface of the dielectric substrate, which is different from said one formation surface of the dielectric substrate where the first strip conductor pattern is formed; and said directional coupler comprises ground conductors, which are placed at a predetermined distance so as to sandwich the dielectric substrate where a pair of the strip conductor patterns are formed.

This produces the following effects: a directional coupler of a suspended strip line, which has good characteristics such as directivity and reflection, can be configured.

A directional coupler according to the present invention is devised in the following manner: a primary line is provided by the first strip conductor pattern that is formed on one formation surface of a dielectric substrate; a subsidiary line is provided by the second strip conductor pattern that is formed in the other formation surface of the dielectric substrate, which is different from said one formation surface of the dielectric substrate where the first strip conductor pattern is formed; and said directional coupler comprises ground conductors, which are placed at a predetermined distance so as to sandwich the dielectric substrate where a pair of the strip conductor patterns are formed.

This produces the following effects: a directional coupler of a suspended strip line, which has good characteristics such as directivity and reflection, can be configured.

A directional coupler according to the present invention is devised in the following manner: a primary line is provided by the first strip conductor pattern that is formed on one formation surface of a dielectric substrate; a subsidiary line is provided by the second strip conductor pattern that is formed in the other formation surface of the dielectric substrate, which is different from said one formation surface of the dielectric substrate where the first strip conductor pattern is formed; and said directional coupler comprises ground conductors, which are placed at a predetermined distance so as to sandwich the dielectric substrate where a pair of the strip conductor patterns are formed.

This produces the following effects: a directional coupler of a suspended strip line, which has good characteristics such as directivity and reflection, can be configured.

A directional coupler according to the present invention is devised in the following manner: a primary line is provided by the first strip conductor pattern that is formed on one formation surface of a dielectric substrate; a subsidiary line is provided by the second strip conductor pattern that is formed in the other formation surface of the dielectric substrate, which is different from said one formation surface of the dielectric substrate where the first strip conductor pattern is formed; and said directional coupler comprises ground conductors, which are placed at a predetermined distance so as to sandwich the dielectric substrate where a pair of the strip conductor patterns are formed.

This produces the following effects: a directional coupler of a suspended strip line, which has good characteristics such as directivity and reflection, can be configured.

A directional coupler according to the present invention is devised in the following manner: a primary line is provided by the first strip conductor pattern that is formed on one formation surface of a dielectric substrate; a subsidiary line is provided by the second strip conductor pattern that is formed in the other formation surface of the dielectric substrate, which is different from said one formation surface of the dielectric substrate where the first strip conductor pattern is formed; and said directional coupler comprises ground conductors, which are placed at a predetermined distance so as to sandwich the dielectric substrate where a pair of the strip conductor patterns are formed.

This produces the following effects: a directional coupler of a suspended strip line, which has good characteristics such as directivity and reflection, can be configured.

A directional coupler according to the present invention is devised in the following manner: a primary line and a subsidiary line are provided by a strip conductor pattern that is formed on one formation surface of the dielectric substrate; and said directional coupler comprises an ground conductor formed on said one formation surface of the dielectric substrate, on which the strip conductor pattern is formed.

This produces the following effects: a directional coupler of a coplanar waveguide, which has good characteristics such as directivity and reflection, can be configured.

A directional coupler according to the present invention is devised in the following manner: a primary line and a subsidiary line are provided by a strip conductor pattern that is formed on one formation surface of the dielectric substrate; and said directional coupler comprises an ground conductor formed on said one formation surface of the dielectric substrate, on which the strip conductor pattern is formed.

This produces the following effects: a directional coupler of a coplanar waveguide, which has good characteristics such as directivity and reflection, can be configured.

A directional coupler according-to the present invention is devised in the following manner: a primary line and a subsidiary line are provided by a strip conductor pattern that is formed on one formation surface of the dielectric substrate; and said directional coupler comprises an ground conductor formed on said one formation surface of the dielectric substrate, on which the strip conductor pattern is formed.

This produces the following effects: a directional coupler of a coplanar waveguide, which has good characteristics such as directivity and reflection, can be configured.

A directional coupler according to the present invention is devised in the following manner: a primary line and a subsidiary line are provided by a strip conductor pattern that is formed on one formation surface of the dielectric substrate; and said directional coupler comprises an ground conductor formed on said one formation surface of the dielectric substrate, on which the strip conductor pattern is formed.

This produces the following effects: a directional coupler of a coplanar waveguide, which has good characteristics such as directivity and reflection, can be configured.

A directional coupler according to the present invention is configured to comprise an inductive element that is mounted on a primary line and a subsidiary line, and that compensates for a series inductive component equivalently possessed by the coupled line.

This produces the following effects: compensation for the difference in phase velocity between the even mode and the odd mode becomes possible, which enables us to configure a directional coupler that has good characteristics such as directivity and reflection.

A directional coupler according to the present invention is configured to use an inductor, which is mounted between the input/output terminal and the coupled line, as an inductive element.

This produces the following effects: compensation for the difference in phase velocity between the even mode and the odd mode becomes possible, which enables us to configure a directional coupler that has good characteristics such as directivity and reflection.

A directional coupler according to the present invention is configured to use a high impedance line, which is provided between the input/output terminal and the coupled line, as an inductive element.

This produces the following effects: work such as solder becomes unnecessary, which enables us to produce the directional coupler easily; and at the same time, the necessity of forming an ground conductor pattern is avoided.

A directional coupler according to the present invention is devised in the following manner: a primary line and a subsidiary line are provided by a strip conductor pattern that is formed on one formation surface of the dielectric substrate; and said directional coupler comprises an ground conductor formed on the other formation surface of the dielectric substrate, which is different from said one formation surface on which the strip conductor pattern is formed.

This produces the following effects: a directional coupler of a microstrip line, which has good characteristics such as directivity and reflection, can be configured.

A directional coupler according to the present invention is devised in the following manner: a primary line and a subsidiary line are provided by a strip conductor pattern that is formed on one formation surface of the dielectric substrate; and said directional coupler comprises an ground conductor formed on the other formation surface of the dielectric substrate, which is different from said one formation surface on which the strip conductor pattern is formed.

This produces the following effects: a directional coupler of a microstrip line, which has good characteristics such as directivity and reflection, can be configured.

A directional coupler according to the present invention is devised in the following manner: a primary line and a subsidiary line are provided by a strip conductor pattern that is formed on one formation surface of the dielectric substrate; and said directional coupler comprises an ground conductor formed on the other formation surface of the dielectric substrate, which is different from said one formation surface on which the strip conductor pattern is formed.

This produces the following effects: a directional coupler of a microstrip line, which has good characteristics such as directivity and reflection, can be configured.

### BRIEF DESCRIPTION OF DRAWINGS

FIG. 1 is a diagram illustrating a configuration of a conventional directional coupler, which was disclosed in JP-B No. 03-73164.

FIG. 2 is a diagram illustrating a cross section of a directional coupler taken along a line A-A′ shown in FIG. 1.

FIGS. 3(a) and 3(b) show diagrams, each of which illustrates electric field distribution of a directional coupler shown in FIG. 2.

FIG. 4 is a diagram illustrating a configuration of a directional coupler according to a first embodiment of the present invention.

FIG. 5 is a diagram illustrating a cross section of a directional coupler taken along a line A-A′ shown in FIG. 4.

FIGS. 6(a) and 6(b) show diagrams, each of which illustrates an equivalent circuit of a coupled line, which is provided by a directional coupler shown in FIG. 4; and capacitors.

FIGS. 7(a) and 7(b) shows diagrams, each of which illustrates electric field distribution of a directional coupler shown in FIG. 5.

FIG. 8 is a diagram illustrating a configuration of a directional coupler according to a second embodiment of the present invention.

FIG. 9 is a diagram illustrating a configuration of a directional coupler according to a third embodiment of the present invention.

FIG. 10 is a diagram illustrating a configuration of a directional coupler according to a fourth embodiment of the present invention.

FIGS. 11(a) and 11(b) show explanatory diagrams, each of which illustrates effects of a directional coupler according to a fourth embodiment of the present invention.

FIG. 12 is a diagram illustrating a configuration of a directional coupler according to a fifth embodiment of the present invention.

FIG. 13 is a diagram illustrating a cross section of a directional coupler taken along a line A-A′ shown in FIG. 12.

FIGS. 14(a) and 14(b) show diagrams, each of which illustrates electric field distribution of a directional coupler shown in FIG. 13.

FIG. 15 is a diagram illustrating a configuration of a directional coupler according to a sixth embodiment of the present invention.

FIG. 16 is a diagram illustrating a cross section of a directional coupler taken along a line A-A′ shown in FIG. 15.

FIGS. 17(a) and 17(b) show diagrams, each of which illustrates an equivalent circuit of a coupled line, which is provided by a directional coupler shown in FIG. 15; and inductors.

FIG. 18 shows diagrams, each of which illustrates electric field distribution of a directional coupler taken along a line A-A′ shown in FIG. 16.

FIG. 19 is a diagram illustrating a configuration of a directional coupler according to a seventh embodiment of the present invention.

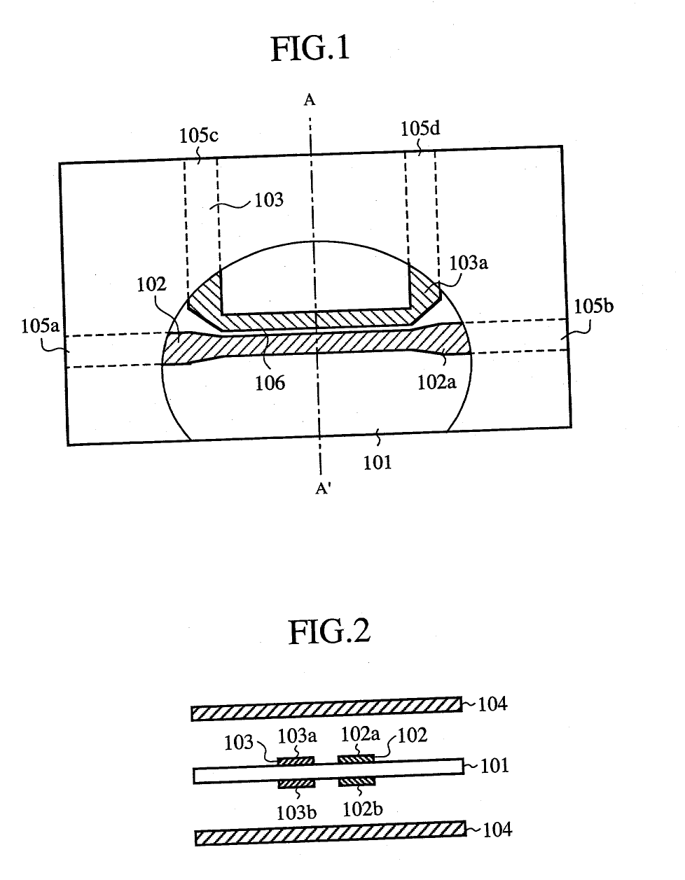

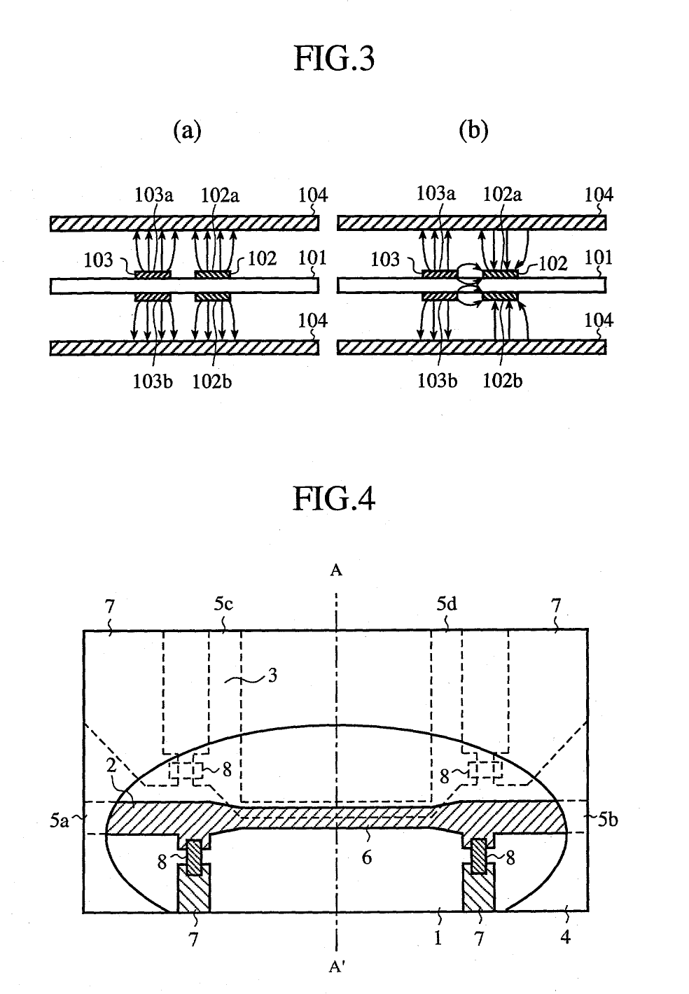

### BEST METHOD FOR CARRYING OUT THE INVENTION

For the purpose of describing the present invention in more detail, best methods for embodying the invention will be described with reference to attached drawings as below.

First Embodiment

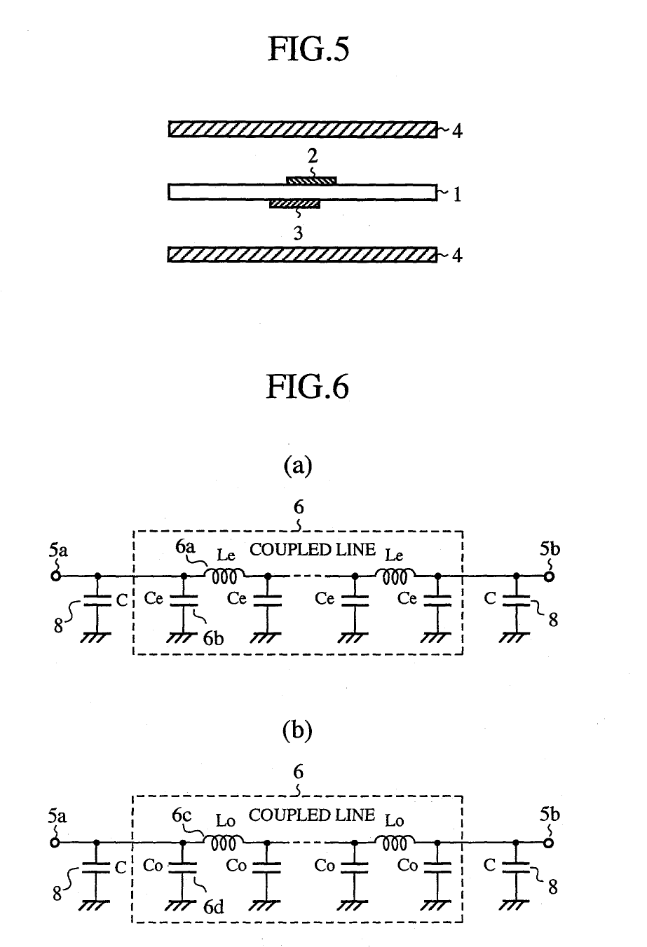

FIG. 4 is a diagram illustrating a configuration of a directional coupler according to a first embodiment of the present invention. In addition, FIG. 5 is a diagram illustrating a cross section of the directional coupler taken along a line A-A′ in FIG. 4.

In FIGS. 4 and 5, a reference numeral 1 is a dielectric substrate having two formation surfaces; reference numerals 2 and 3 are strip conductor patterns (primary line and subsidiary line), each of which is propagated by a high frequency signal; a reference numeral 4 is an ground conductor; reference numerals 5a, 5b, 5c, and 5d are input/output terminals for inputting and outputting a high frequency signal; a reference numeral 6 is a coupled line; a reference numeral 7 represents ground conductor patterns; and a reference numeral 8 represents capacitors (reactive element, capacitive element).

The strip conductor pattern 2 (a first strip conductor pattern) is formed on one formation surface of the dielectric substrate 1; and the strip conductor pattern 3 (a second strip conductor pattern) is formed on the other formation surface of the dielectric substrate 1. Thus, the dielectric substrate 1 is sandwiched between the strip conductor patterns 2 and 3. In addition, the strip conductor pattern 2 has the input/output terminals 5a and 5b; and the strip conductor pattern 3 has the input/output terminals 5c and 5d. The strip conductor patterns 2 and 3 are adjacent to each other so that they are electromagnetically coupled in the coupled line 6. A length of the coupled line 6 is about ¼ of a wavelength at a desired frequency.

Additionally, each of the formation surfaces of the dielectric substrate 1 is provided with the ground conductor pattern 7. The ground conductor patterns 7 of both of the formation surfaces are placed so as not to be opposed to each other. Each of the four capacitors 8 is connected between each of lines and each of the ground conductor patterns 7; in this case, each of the lines is connected between each of the input/output terminals 5a, 5b, 5c, 5d and the coupled line 6. Moreover, two ground conductors 4 are placed in parallel at a predetermined distance so as to sandwich the dielectric substrate 1, on which the strip conductor patterns 2 and 3, the ground conductor pattern 7, and the four capacitors 8 are placed. In this manner, the directional coupler according to the first embodiment constitutes a suspended strip line.

FIGS. 6(a) and 6(b) show diagrams, each of which illustrates an equivalent circuit of the coupled line 6, which is provided by the directional coupler shown in FIG. 4; and the capacitors 8. FIGS. 6(a) and 6(b) show an excitation in an even mode, and an excitation in an odd mode respectively. It should be noted that it is assumed that a loss of the coupled line 6 is disregarded.

In FIG. 6(a), reference numerals 6a and 6b are inductance Le (a reactive component and a series inductive component) per unit length, and capacitance Ce (a reactive component and a parallel capacitive component) per unit length, of the coupled line 6 respectively, which is excited in the even mode.

On the other hand, in FIG. 6(b), reference numerals 6c and 6d are inductance Lo (reactive component and series inductive component) per unit length, and capacitance Co (reactive component and parallel capacitive component), of the coupled lines 6 respectively, which is excited in the odd mode.

As shown in FIG. 6, the inductances 6a and 6c are connected in series between the input/output terminals 5a and 5b. In addition, the capacitances 6b and 6d are connected in parallel so that each of the capacitances 6b and 6d is connected from a line between the input/output terminal 5a and the input/output terminal 5b to the ground.

Additionally, as is the case with the capacitances 6b and 6d, the capacitors 8 are connected in parallel so that each of the capacitors 8 is connected from a position between the input/output terminal 5a or 5b and the coupled line 6 to the ground.

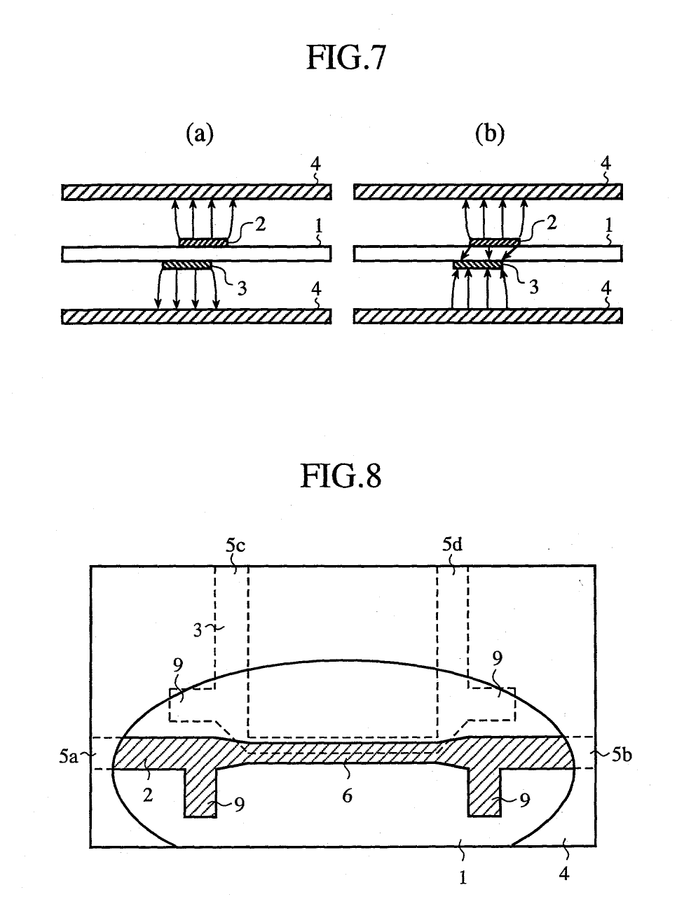

FIG. 7 illustrates electric field distribution of the directional coupler shown in FIG. 5; and FIGS. 7(a) and 7(b) are a diagram in the even mode and a diagram in the odd mode respectively. Arrows in the diagrams represent electric fields.

The dielectric substrate 1 has almost no electric field in the even mode shown in FIG. 7(a), whereas electric fields are concentrated on the dielectric substrate 1 in the odd mode shown FIG. 7(b). Because of it, in the odd mode, a wavelength decreasing rate by the dielectric substrate 1 becomes higher than that in the even mode. Therefore, difference in the wavelength shortening rate between these modes causes phase velocity in the odd mode to decrease more than phase velocity in the even mode. In response to the difference in the phase velocity, characteristics of the conventional directional coupler were degraded.

For this reason, in the first embodiment, capacitance equivalently possessed by the coupled line 6 is compensated by providing the capacitors 8, which are connected in parallel so that each of the capacitors 8 is connected from a line between each of the input/output terminals 5a, 5b, 5c, 5d and the coupled line 6 to the ground. This reduces the difference in the phase velocity between the modes, which results in improvement of characteristic degradation of the directional coupler. Reasons for this will be described as below.

On the assumption that impedance of the coupled line 6 excited by the even mode and impedance of the coupled line 6 excited by the odd mode are Ze and Zo respectively, Ze and Zo are given by expressions (1a) and (1b) respectively.

Ze=[Le/Ce]^{0.5} (1a)

Zo=[Lo/Co]^{0.5} (1b)

In addition, on the assumption that phase velocity of the coupled line 6 excited by the even mode and phase velocity of the coupled line 6 excited by the odd mode are Ve and Vo respectively, Ve and Vo are given by expressions (2a) and (2b) respectively.

Ve=[Le*Ce]^{-0.5} (2a)

Vo=[Lo*Co]^{-0.5} (2b)

If the impedance Ze in the even mode is compared with the impedance Zo in the odd mode, Ze is generally larger than Zo. In other words, judging from the expressions (1a) and (1b), in the even mode, a value of the inductance Le is relatively large; and in the odd mode, a value of the capacitance Co is relatively large. On the other hand, judging from the expressions (2a) and (2b), phase velocity Ve and Vo of the coupled line 6 depends on the product of inductance and capacitance.

Therefore, as regards a change in phase velocity for changes in inductance and capacitance, it is found out that capacitance Ce is predominant in the even mode, and that inductance Lo is predominant in the odd mode.

In the first embodiment, adding the capacitors 8 increases capacitance Ce and Co of the coupled line 6. Inductance Le is relatively large and capacitance Ce is small in the even mode. Because of it, when addition of the capacitor 8 causes the capacitance Ce to increase, the phase velocity in the even mode will decrease to a large extent. On the other hand, capacitance Co is relatively large and inductance Lo is small in the odd mode. Because of it, even if addition of the capacitor 8 causes the capacitance Co to increase, the phase velocity in the odd mode is not influenced to a large extent.

In this manner, the difference in the phase velocity between the modes caused by the difference in the wavelength shortening rate can be compensated by increasing capacitance of the coupled line 6, which results in decrease in the phase velocity in the even mode without great influence on the phase velocity in the odd mode. Capacitance C of the capacitor 8 should be determined so that a value of the phase velocity in the even mode approximates to a value of the phase velocity in the odd mode as closely as possible.

Relevance of a change in phase velocity to changes in inductance and capacitance in each mode described above can also be described as below.

On the assumption that changes in the phase velocity Ve and Vo (total differential) are ΔVe and ΔVo respectively, rates of change [ΔVe/Ve] and [ΔVo/Vo] of phase velocity Ve and Vo can be determined by the following expressions respectively according to the expressions (2a) and (2b):

[ΔVe/Ve]=−0.5[ΔLe/Le+ΔCe/Ce] (3a)

[ΔVo/Vo]=−0.5[ΔLo/Lo+ΔCo/Co] (3b)

As described above, if the impedance Ze in the even mode is compared with the impedance Zo in the odd mode, Ze is larger than Zo. Because of it, in the even mode, a value of the inductance Le is relatively large; and in the odd mode, a value of the capacitance Co is relatively large. Therefore, if [ΔLe/Le] and [ΔCo/Co] are disregarded, expressions (3a) and (3b) can be approximated to expressions (4a) and (4b) respectively.

[ΔVe/Ve]≈−0.5[ΔCe/Ce] (4a)

[ΔVo/Vo]≈−0.5[ΔLo/Lo] (4b)

To be more specific, judging from the expression (4a), it is considered that the rate of change in phase velocity [ΔVe/Ve] in the even mode decreases when the rate of change in capacitance [ΔCe/Ce] increases, and that the rate of change in phase velocity [ΔVe/Ve] does not depend on the rate of change in inductance [ΔLe/Le] approximately.

In addition, judging from the expression (4b), it is considered that the rate of change in phase velocity [ΔVo/Vo] in the odd mode decreases when the rate of change in inductance [ΔLo/Lo] increases, and that the rate of change in phase velocity [ΔVo/Vo] does not depend on the rate of change in capacitance [ΔCo/Co] approximately.

The results of the above-mentioned consideration will be summarized as below.

Relation of phase velocity to capacitance and inductance of a coupled line:

Increase in capacitance [symbol] Great decrease in the even mode, but little change in the odd mode

Increase in inductance [symbol] Great decrease in the even mode, but little change in the odd mode

According to such a concept, characteristic degradation of the directional coupler can be improved by the following method: difference in phase velocity, which has been caused by difference between a wavelength shortening rate in the even mode and a wavelength shortening rate in the odd mode, is compensated by increasing capacitance of the coupled line 6 using the capacitors 8.

As described above, according to the first embodiment, in the directional coupler comprising the dielectric substrate 1 the strip conductor patterns 2 and 3, which are provided on one formation surface and the other formation surface of the dielectric substrate 1 respectively as a primary line and a subsidiary line so as to sandwich the dielectric substrate 1, and which have the coupled line 6 where the strip conductor patterns 2 and 3 are electromagnetically coupled to each other; and the ground conductors 4, which are placed at a predetermined distance so as to sandwich the dielectric substrate 1; the capacitors 8, which are connected in parallel, are provided for the coupled line 6 of the directional coupler. Because of it, there is obtained an effect of being capable of increasing the capacitance of the coupled line 6, thus enabling us to configure a directional coupler of a suspended strip line, of which characteristic degradation caused by difference in wavelength shortening rates is improved by decreasing phase velocity in the even mode greatly without great influence on phase velocity in the odd mode.

Second Embodiment

FIG. 8 is a diagram illustrating a configuration of a directional coupler according to a second embodiment of the present invention.

In FIG. 8, a reference numeral 9 represents open stubs (reactive element and capacitive element), which are provided between each of the input/output terminals 5a, 5b, 5c, 5d and the coupled line 6 respectively. Like parts are identified by the same reference numerals as in FIG. 4.

Instead of the capacitors 8 shown in the first embodiment, the open stubs 9 are provided in the second embodiment. Adjusting lengths of the open stubs 9 permits the open stubs 9 to work in the same manner as the capacitors 8. Therefore, such a configuration can produce the same effects as the first embodiment.

In addition, because the necessity of mounting the capacitors 8 is avoided, work such as soldering becomes unnecessary. This produces an effect of enabling us to produce the directional coupler easily.

Moreover, because the necessity of forming the ground conductor patterns 7 of the first embodiment is avoided, an effect of excluding influence on characteristics of the directional coupler, which is caused by the ground conductor patterns 7 in proximity to the strip conductor patterns 2 and 3, is produced.

Third Embodiment

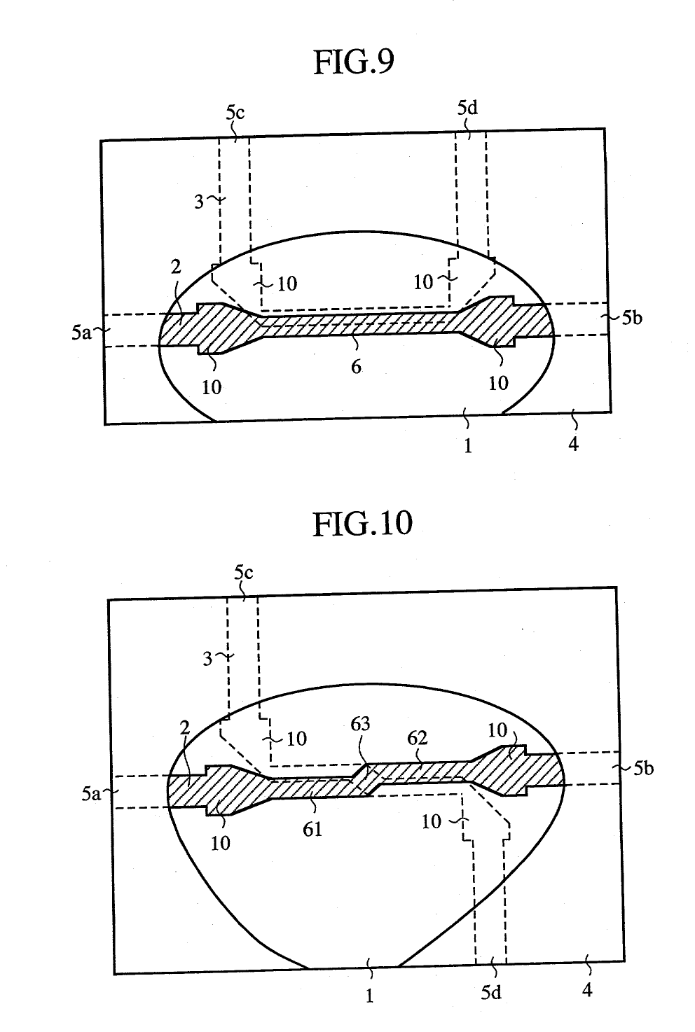

FIG. 9 is a diagram illustrating a configuration of a directional coupler according to a third embodiment of the present invention.

In FIG. 9, a reference numeral 10 represents low impedance lines (reactive element and capacitive element), which are provided between each of the input/output terminals 5a, 5b, 5c, 5d and the coupled line 6 respectively. Like parts are identified by the same reference numerals as in FIG. 4.

Instead of the capacitors 8 shown in the first embodiment, the low impedance lines 10 are provided in the third embodiment. The low impedance lines 10 work in the same manner as the capacitors 8. Therefore, such a configuration can produce the same effects as the first embodiment.

In addition, because the necessity of mounting the capacitors 8 or the open stubs 9 of the second embodiment is avoided, an effect of reducing a loss of the directional coupler is produced as compared with the first and the second embodiment.

Fourth Embodiment

FIG. 10 is a diagram illustrating a configuration of a directional coupler according to a fourth embodiment of the present invention.

In FIG. 10, reference numerals 61 and 62 are coupled lines. Like parts are identified by the same reference numerals as in FIGS. 4 and 9.

The strip conductor patterns 2 and 3, which are formed on different formation surfaces of the dielectric substrate 1 so that the strip conductor patterns sandwich the dielectric substrate 1, are adjacent to each other so as to be electromagnetically coupled in the coupled lines 61 and 62. The directional coupler shown in FIG. 10 has an area 63 (intersection area), where propagating directions of high frequency signals intersect in a decussate form at a center of a projection image of the coupled lines 61 and 62 when each of the strip conductor patterns 2 and 3 is projected from a normal line direction of a formation surface to the same plane parallel to the formation surface of the dielectric substrate 1 (any one of the formation surfaces can be used).

The coupled lines 61 and 62 have the area 63 where those coupled lines are electromagnetically coupled to each other. Therefore, on the assumption that the area 63 is a boundary, the strip conductor pattern 2 is projected above the strip conductor pattern 3 on the right side of FIG. 10, whereas the strip conductor pattern 3 is projected above the strip conductor pattern 2 on the left side of FIG. 10. A length of each coupled line 61 or 62 is about ⅛ of a wavelength in a desired frequency. Therefore, a total length of the coupled lines 61 and 62 becomes about ¼ of a wavelength. Additionally, degrees of electromagnetic coupling of the coupled lines 61 and 62 are equal.

In the fourth embodiment, the strip conductor patterns 2 and 3 are provided so that those strip conductor patterns intersect between the coupled lines 61 and 62. Connection of the coupled lines 61 and 62 in series works in the same manner as the coupled line 6 shown in the third embodiment. Therefore, such a configuration can produce the same effects as the third embodiment.

Effects peculiar to the fourth embodiment, which can be produced by providing the area 63, will be described as below.

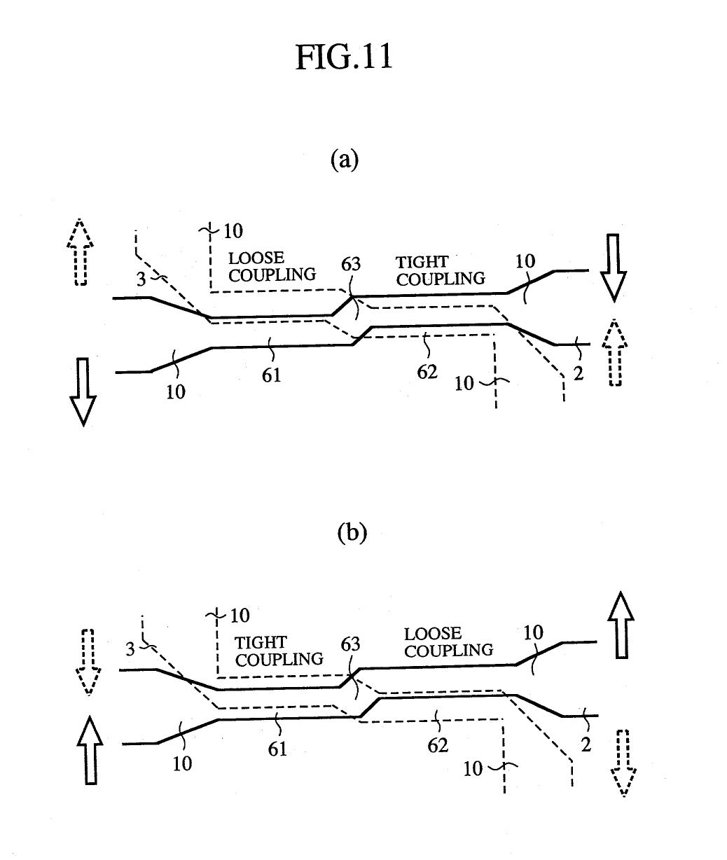

FIGS. 11(a) and 11(b) show explanatory diagrams, each of which illustrates effects of the directional coupler of the embodiments according to the present invention. Both of the diagrams magnify the coupled lines 61 and 62 of the directional coupler. Like parts are identified by the same reference numerals as in FIG. 10.

In FIGS. 11(a) and 11(b), as regards the strip conductor patterns 2 and 3, their mutual relative positions deviate to a direction parallel to the dielectric substrate 1 while keeping their shapes; and at the same time, their relative positions deviate to a direction orthogonal to a propagating direction of a high frequency signal in the coupled lines 61 and 62. In FIG. 11(a), the strip conductor pattern 2 deviates to a downward direction, and the strip conductor pattern 3 deviates to an upward direction. In FIG. 11(b), the strip conductor pattern 2 deviates to an upward direction, and the strip conductor pattern 3 deviates to a downward direction. Therefore, the directions of the deviations (shown by block arrows using a solid line or a broken line in FIG. 11) are mutually reversed. These deviations occur in manufacturing processes. If a normal directional coupler is used, the deviations cause a degree of coupling to change from a desired design value.

On the other hand, as regards the directional coupler of the fourth embodiment, the coupled lines 61 and 62 have the area 63 where those coupled lines are electromagnetically coupled to each other. Because of it, in the case of FIG. 11(a), the coupled line 62 is loosely coupled whereas the coupled line 61 is tightly coupled. In the case of FIG. 11(b), the coupled line 61 is tightly coupled whereas the coupled line 62 is loosely coupled. Therefore, it is so devised that regardless of a direction of a deviation, a deviation in one degree of coupling can be compensated by a deviation in the other degree of coupling.

Therefore, the following effect can be produced: for a deviation in relative positions of the strip conductor patterns 2 and 3, a deviation in a degree of coupling of the directional coupler can be reduced, which enables us to produce the directional coupler easily.

As described above, according to the fourth embodiment, the following effects can be produced: the directional coupler is configured to have an area 63, where propagating directions of a high frequency signal intersect at a center of a projection image of the coupled lines 61 and 62, which are coupled electromagnetically, at the time of projection from a normal line direction of a formation surface of the dielectric substrate 1 to a plane parallel to the formation surface; because of it, even if mutual relative positions of the strip conductor patterns 2 and 3 deviate to a direction parallel to the dielectric substrate 1 and at the same time the mutual relative positions deviate to a direction orthogonal to the propagating direction of the high frequency signal in the coupled line 61 and 62, a deviation in a degree of coupling can be reduced, which enables us to produce the directional coupler easily.

It should be noted that the fourth embodiment can be applied to the directional couplers (the first, the second, and the third embodiment) in which the strip conductor pattern 2 is formed on one formation surface of the dielectric substrate 1 and the strip conductor pattern 3 is formed on the other formation surface.

Fifth Embodiment

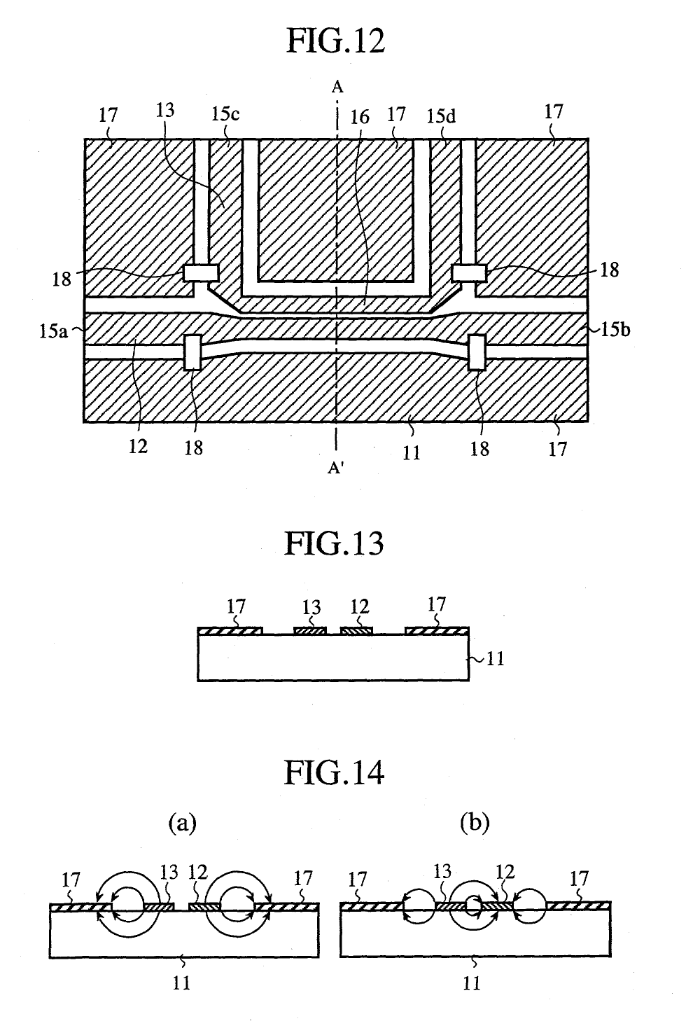

FIG. 12 is a diagram illustrating a configuration of a directional coupler according to a fifth embodiment of the present invention. In addition, FIG. 13 is a diagram illustrating a cross section of the directional coupler taken along a line A-A′ shown in FIG. 12.

In FIGS. 12 and 13, a reference numeral 11 is a dielectric substrate having two formation surfaces; reference numerals 12 and 13 are strip conductor patterns (primary line and subsidiary line), each of which is propagated by a high frequency signal; reference numerals 15a, 15b, 15c, and 15d are input/output terminals for inputting and outputting a high frequency signal; a reference numeral 16 is a coupled line; a reference numeral 17 represents ground conductor patterns; and a reference numeral 18 represents capacitors (reactive element, capacitive element).

Both of the strip conductor patterns 12 and 13 are formed on one formation surface of the dielectric substrate 11. In addition, the strip conductor pattern 12 has the input/output terminals 15a and 15b; and the strip conductor pattern 13 has the input/output terminals 15c and 15d. The strip conductor patterns 12 and 13 are adjacent to each other so that they are electromagnetically coupled in the coupled line 16. A length of the coupled line 16 is about ¼ of a wavelength at a desired frequency.

In addition, ground conductor patterns 17 are also formed on the same formation surface of the dielectric substrate 11 as that formed with the strip conductor patterns 12 and 13. In this case, the conductor patterns 17 are placed so as to surround the strip conductor patterns 12 and 13. Each of the four capacitors 18 is connected between each of lines and each of the ground conductor patterns 17; in this case, each of lines is connected between each of the input/output terminals 15a, 15b, 15c, 15d, and the coupled line 16. In this manner, the directional coupler according to the fifth embodiment constitutes a coplanar waveguide.

As is the case with the directional coupler according to the first embodiment, an equivalent circuit of the directional coupler according to the fifth embodiment is provided in FIG. 6. In addition, electric field distribution of the directional coupler, which was shown in FIG. 13, is illustrated in FIGS. 14(a) and 14(b). FIG. 14(a) shows electric field distribution in the even mode, and FIG. 14(b) shows electric field distribution in the odd mode. Arrows in the diagrams represent electric fields.

Electric field distribution in the even mode of FIG. 14(a) has also a tendency to diffuse into the air among the strip conductor patterns 12, 13 and the ground conductor pattern 17, whereas electric field distribution in the odd mode of FIG. 14(b) concentrates on the inside of the dielectric substrate 11 between the strip conductor patterns 12 and 13, which are adjacent to each other. Therefore, a wavelength shortening rate by the dielectric substrate 11 in the case of the odd mode is higher than that in the case of the even mode, which causes phase velocity in the odd mode to decrease as compared with the even mode, resulting in characteristic degradation of the directional coupler.

Therefore, as is the case with the first embodiment, the following effect can be produced: adding the capacitors 18 compensates for the difference in the phase velocity between the modes, which improves the characteristics of the directional coupler.

As described above, according to the fifth embodiment, in the directional coupler comprising: the dielectric substrate 11; the strip conductor patterns 12 and 13 that are formed in one formation surface of the dielectric substrate 11, and that have the coupled line 16 for electromagnetic coupling; and the ground conductor pattern 17 that is formed on one formation surface of the dielectric substrate 11, where the strip conductor patterns 12 and 13 were formed; the capacitors 18, which are connected in parallel, are provided for the coupled line 16 of the directional coupler. Because of it, there is obtained an effect of being capable of compensating for the difference in the phase velocity between the modes, which allows to configure a directional coupler of the coplanar waveguide, of which characteristic degradation is improved.

In addition, according to the fifth embodiment, because all of the strip conductor patterns 12, 13, and the ground conductor pattern 17 are formed in one formation surface of the dielectric substrate 11, the following effect can be obtained: as compared with the first embodiment, it is possible to mount the capacitors 18 more easily.

It should be noted that the same effect can be produced even if the ground conductor pattern 17 is formed on the other formation surface, which is different from said one formation surface of the dielectric substrate 11 where the strip conductor patterns 12 and 13 are provided.

Moreover, instead of the capacitor 18 shown in the fifth embodiment, the open stub 9 of the second embodiment or the low impedance line 10 of the third embodiment may be used.

Sixth Embodiment

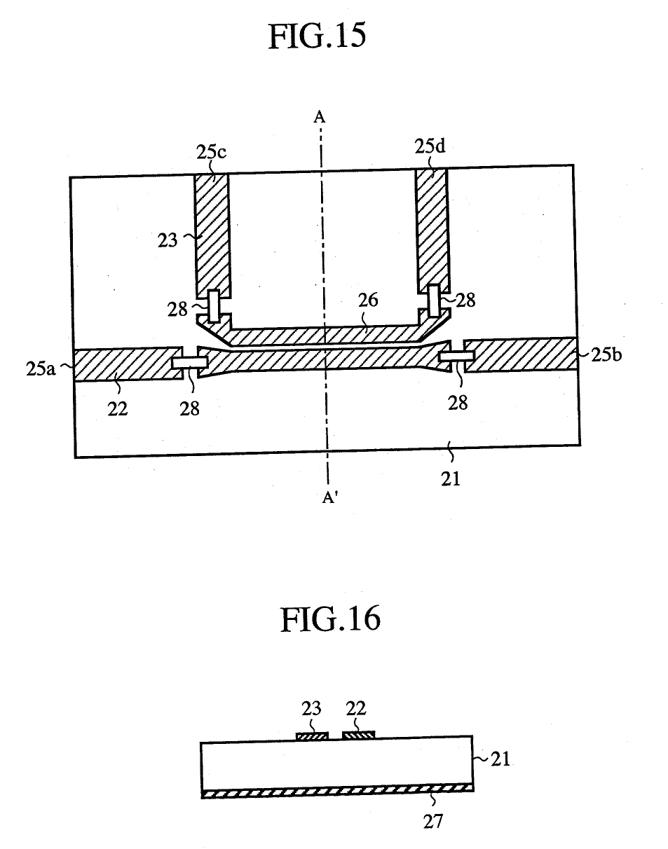

FIG. 15 is a diagram illustrating a configuration of a directional coupler according to a sixth embodiment of the present invention. In addition, FIG. 16 is a diagram illustrating a cross section of the directional coupler taken along a line A-A′ shown in FIG. 15.

In FIGS. 15 and 16, a reference numeral 21 is a dielectric substrate having two formation surfaces; reference numerals 22 and 23 are strip conductor patterns (primary line and subsidiary line), each of which is propagated by a high frequency signal; reference numerals 25a, 25b, 25c, and 25d are input/output terminals for inputting and outputting a high frequency signal; a reference numeral 26 is a coupled line; a reference numeral 27 is an ground conductor pattern; and a reference numeral 28 represents inductors (reactive element, inductive element).

Both of the strip conductor patterns 22 and 23 are formed on one formation surface of the dielectric substrate 21. In addition, the strip conductor pattern 22 has the input/output terminals 25a and 25b; and the strip conductor pattern 23 has the input/output terminals 25c and 25d. The strip conductor patterns 22 and 23 are adjacent to each other so that they are electromagnetically coupled in the coupled line 26. A length of the coupled line 26 is about ¼ of a wavelength at a desired frequency.

An ground conductor pattern 27 is provided on the other formation surface that is different from the one formation surface of the dielectric substrate 21 on which the strip conductor patterns 22 and 23 are provided. Each of the four inductors 28 is connected between each of the input/output terminals 25a, 25b, 25c, 25d and the coupled line 26 respectively. In this manner, the directional coupler according to the sixth embodiment constitutes a microstrip line.

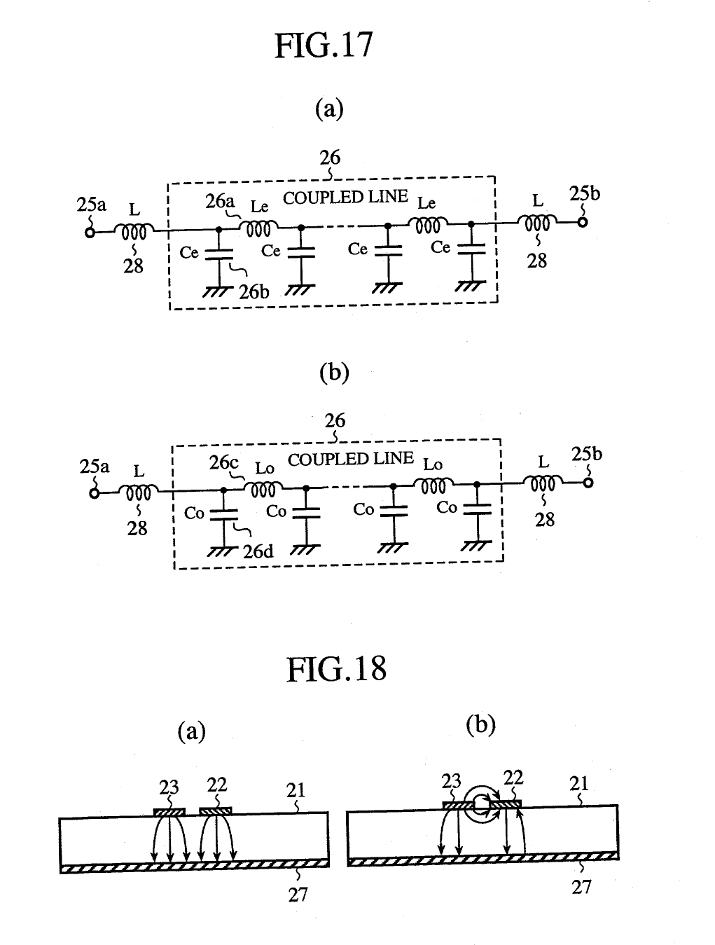

FIGS. 17(a) and 17(b) show diagrams, each of which illustrates an equivalent circuit of the coupled line 26, which is provided by the directional coupler shown in FIG. 15; and the inductors 28. FIGS. 17(a) and 17(b) show an excitation in an even mode, and an excitation in an odd mode respectively. It should be noted that it is assumed that a loss of the coupled line 26 is disregarded.

In FIG. 17(a), reference numerals 26a and 26b are inductance Le (a reactive component and a series inductive component) per unit length, and capacitance Ce (a reactive component and a parallel capacitive component) per unit length, of the coupled line 26 respectively, which is excited in the even mode.

On the other hand, in FIG. 17(b), reference numerals 26c and 26d are inductance Lo (reactive component and series inductive component) per unit length, and capacitance Co (reactive component and parallel capacitive component), of the coupled line 26 respectively, which is excited in the odd mode.

As shown in FIGS. 17(a) and 17(b), the inductances 26a and 26c are connected in series between the input/output terminals 25a and 25b. In addition, the capacitances 26b and 26d are connected in parallel so that each of the capacitances 26b and 26d is connected from a line between the input/output terminal 25a and the input/output terminal 25b to the ground.

As is the case with the inductances 26a and 26c, the inductors 28 are connected in series so that each of the inductors 28 is connected from each of the input/output terminals 25a and 25b to the coupled line 26.

As shown in the first embodiment, impedance Ze in the even mode, and impedance Ze in the odd mode, of the coupled line 26 are given by expressions (1a) and (1b) respectively; and phase velocity Ve in the even mode and phase velocity Vo in the odd mode are given by expressions (2a) and (2b) respectively.

FIG. 18 illustrates electric field distribution of the directional coupler shown in FIG. 16; and FIGS. 18(a) and 18(b) are a diagram in the even mode and a diagram in the odd mode respectively. Arrows in the diagrams represent electric fields.

In the even mode shown in FIG. 18(a), electric field distribution concentrates on the inside of the dielectric substrate 21, which is a portion between the following: the strip conductor patterns 22, 23; and the ground conductor pattern 27. On the other hand, in the odd mode shown in FIG. 18(b), electric field distribution has also a tendency to diffuse into the air between the strip conductor patterns 22 and 23. Because of it, in the even mode, a wavelength decreasing rate by the dielectric substrate 21 becomes higher than that in the odd mode. Therefore, difference in the wavelength shortening rate between the modes causes phase velocity in the even mode to decrease more than phase velocity in the odd mode. In response to the difference in the phase velocity, characteristics of the conventional directional coupler were degraded.

In the sixth embodiment, contrary to the first, the second, the third, the fourth, and the fifth embodiment, a wavelength shortening rate of the even mode is higher than that in the odd mode. In such a case, according to the latter half of the consideration result shown in the first embodiment, inductance component of the coupled line 26 is increased to compensate for the difference in phase velocity between the modes.

To be more specific, as is the case with inductance Le and Lo of the coupled line 26, when the phase velocity in the even mode is low as a result of the difference in the wavelength shortening rate, the directional coupler is provided with the inductors 28 that are connected to a line, which is connected between the input/output terminals 25a and 25b, in series to increases inductance of the coupled line 26. This enables great decrease in the phase velocity in the odd mode without a considerable influence on the phase velocity in the even mode. Inductance of the inductor 28 should be determined so that a value of the phase velocity in the even mode approximates to a value of the phase velocity in the odd mode as closely as possible.

As described above, according to the sixth embodiment, in the directional coupler comprising: the dielectric substrate 21; the strip conductor patterns 22 and 23 that are formed in one formation surface of the dielectric substrate 21, and that have the coupled line 26 for electromagnetic coupling; and an ground conductor pattern 27 formed on the other formation surface that is different from said one formation surface of the dielectric substrate 21 on which the strip conductor patterns 22 and 23 are formed; the inductors 28, which are connected in series, are provided for the coupled line 26 of the directional coupler. Therefore, there is obtained an effect of being capable of configuring a directional coupler of the microstrip line that can decrease the phase velocity in the odd mode without considerable influence on the phase velocity in the even mode, resulting in improvement in characteristic degradation.

Seventh Embodiment

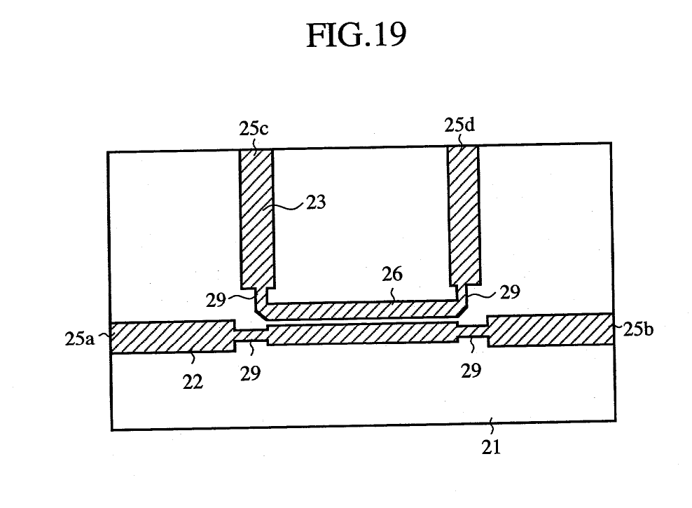

FIG. 19 is a diagram illustrating a configuration of a directional coupler according to a seventh embodiment of the present invention.

In FIG. 19, a reference numeral 29 represents high impedance lines (reactive element and inductive element), which are provided between each of the input/output terminals 25a, 25b, 25c, 25d and the coupled line 26 respectively. Like parts are identified by the same reference numerals as in FIG. 15.

Instead of the inductors 28 shown in the sixth embodiment, the high impedance lines 29 are provided in the seventh embodiment. The high impedance lines 29 work in the same manner as the inductors 28. Therefore, such a configuration can produce the same effects as the fifth embodiment.

In addition, because the necessity of mounting the inductors 28 is avoided, work such as soldering becomes unnecessary. This produces an effect of enabling us to produce the directional coupler easily.

### INDUSTRIAL APPLICABILITY

As described above, the directional coupler according to the present invention is suitable for a communication system that uses microwaves and millimeter waves, and that couples a high frequency signal, which is inputted in a primary line, with a subsidiary line while realizing good characteristics such as directivity and reflection.

1. A directional coupler comprising: a primary line and a subsidiary line through which a high frequency signal propagates; and a coupled line in which the primary line is electromagnetically coupled to the subsidiary line; said directional coupler comprising:
a reactive element that is mounted on the primary line and the subsidiary line, and that compensates for a reactive component equivalently possessed by the coupled line.

2. A directional coupler comprising: a dielectric substrate having two formation surfaces; a primary line and a subsidiary line, which are formed on the dielectric substrate, and each of which has an input/output terminal for inputting/outputting a high frequency signal at both ends, and through which the high frequency signal propagates; and a coupled line in which the primary line electromagnetically coupled to the subsidiary line; wherein as compared with electric field distribution in an even mode in which the primary line and the subsidiary line are excited at in-phase equal amplitude, electric field distribution in an odd mode, in which the primary line and the subsidiary line are excited at out-of-phase equal amplitude, concentrates on the inside of the dielectric substrate; said directional coupler comprising:
a capacitive element that is mounted on the primary line and the subsidiary line, and that compensates for a parallel capacitive component equivalently possessed by the coupled line.

3. A directional coupler according to claim 2, wherein:
the capacitive element is a capacitor that is connected from a position between the input/output terminal and a coupled line to ground.

4. A directional coupler according to claim 2, wherein:
the capacitive element is an open stub that is provided between the input/output terminal and the coupled line.

5. A directional coupler according to claim 2, wherein:
the capacitive element is a low impedance line that is provided between the input/output terminal and the coupled line.

6. A directional coupler according to claim 2, wherein:
the primary line and the subsidiary line have an intersection area where propagating directions of a high frequency signal intersect at a center of the coupled line at the time of projection from a normal line direction of a formation surface to a plane parallel to the formation surface.

7. A directional coupler according to claim 3, wherein:
the primary line and the subsidiary line have an intersection area where propagating directions of a high frequency signal intersect at a center of the coupled line at the time of projection from a normal line direction of a formation surface to a plane parallel to the formation surface.

8. A directional coupler according to claim 4, wherein:
the primary line and the subsidiary line have an intersection area where propagating directions of a high frequency signal intersect at a center of the coupled line at the time of projection from a normal line direction of a formation surface to a plane parallel to the formation surface.

9. A directional coupler according to claim 5, wherein:
the primary line and the subsidiary line have an intersection area where propagating directions of a high frequency signal intersect at a center of the coupled line at the time of projection from a normal line direction of a formation surface to a plane parallel to the formation surface.

10. A directional coupler according to claim 2, wherein:
the primary line is provided by a first strip conductor pattern that is formed in one formation surface of a dielectric substrate;
the subsidiary line is provided by a second strip conductor pattern that is formed in the other formation surface of the dielectric substrate, which is different from said one formation surface of the dielectric substrate on which the first strip conductor pattern is formed; and
said directional coupler comprises ground conductors, which are placed at a predetermined distance so as to sandwich the dielectric substrate where a pair of the strip conductor patterns are formed.

11. A directional coupler according to claim 3, wherein:
the primary line is provided by a first strip conductor pattern that is formed in one formation surface of a dielectric substrate;
the subsidiary line is provided by a second strip conductor pattern that is formed in the other formation surface of the dielectric substrate, which is different from said one formation surface of the dielectric substrate on which the first strip conductor pattern is formed; and
said directional coupler comprises ground conductors, which are placed at a predetermined distance so as to sandwich the dielectric substrate where a pair of the strip conductor patterns are formed.

12. A directional coupler according to claim 4, wherein:
the primary line is provided by a first strip conductor pattern that is formed in one formation surface of a dielectric substrate;
the subsidiary line is provided by a second strip conductor pattern that is formed in the other formation surface of the dielectric substrate, which is different from said one formation surface of the dielectric substrate on which the first strip conductor pattern is formed; and
said directional coupler comprises ground conductors, which are placed at a predetermined distance so as to sandwich the dielectric substrate where a pair of the strip conductor patterns are formed.

13. A directional coupler according to claim 5, wherein:
the primary line is provided by a first strip conductor pattern that is formed in one formation surface of a dielectric substrate;
the subsidiary line is provided by a second strip conductor pattern that is formed in the other formation surface of the dielectric substrate, which is different from said one formation surface of the dielectric substrate on which the first strip conductor pattern is formed; and
said directional coupler comprises ground conductors, which are placed at a predetermined distance so as to sandwich the dielectric substrate where a pair of the strip conductor patterns are formed.

14. A directional coupler according to claim 6, wherein:
the primary line is provided by a first strip conductor pattern that is formed in one formation surface of a dielectric substrate;
the subsidiary line is provided by a second strip conductor pattern that is formed in the other formation surface of the dielectric substrate, which is different from said one formation surface of the dielectric substrate on which the first strip conductor pattern is formed; and
said directional coupler comprises ground conductors, which are placed at a predetermined distance so as to sandwich the dielectric substrate where a pair of the strip conductor patterns are formed.

15. A directional coupler according to claim 7, wherein:
the primary line is provided by a first strip conductor pattern that is formed in one formation surface of a dielectric substrate;
the subsidiary line is provided by a second strip conductor pattern that is formed in the other formation surface of the dielectric substrate, which is different from said one formation surface of the dielectric substrate on which the first strip conductor pattern is formed; and
said directional coupler comprises ground conductors, which are placed at a predetermined distance so as to sandwich the dielectric substrate where a pair of the strip conductor patterns are formed.

16. A directional coupler according to claim 8, wherein:
the primary line is provided by a first strip conductor pattern that is formed in one formation surface of a dielectric substrate;
the subsidiary line is provided by a second strip conductor pattern that is formed in the other formation surface of the dielectric substrate, which is different from said one formation surface of the dielectric substrate on which the first strip conductor pattern is formed; and
said directional coupler comprises ground conductors, which are placed at a predetermined distance so as to sandwich the dielectric substrate where a pair of the strip conductor patterns are formed.

17. A directional coupler according to claim 9, wherein:
the primary line is provided by a first strip conductor pattern that is formed in one formation surface of a dielectric substrate;
the subsidiary line is provided by a second strip conductor pattern that is formed in the other formation surface of the dielectric substrate, which is different from said one formation surface of the dielectric substrate on which the first strip conductor pattern is formed; and
said directional coupler comprises ground conductors, which are placed at a predetermined distance so as to sandwich the dielectric substrate where a pair of the strip conductor patterns are formed.

18. A directional coupler according to claim 2, wherein:
each of the primary line and the subsidiary line is provided by a strip conductor pattern that is formed in one formation surface of a dielectric substrate; and
said directional coupler comprises an ground conductor that is formed on said one formation surface of the dielectric substrate where the strip conductor pattern is formed.

19. A directional coupler according to claim 3, wherein:
each of the primary line and the subsidiary line is provided by a strip conductor pattern that is formed in one formation surface of a dielectric substrate; and
said directional coupler comprises an ground conductor that is formed on said one formation surface of the dielectric substrate where the strip conductor pattern is formed.

20. A directional coupler according to claim 4, wherein:
each of the primary line and the subsidiary line is provided by a strip conductor pattern that is formed in one formation surface of a dielectric substrate; and
said directional coupler comprises an ground conductor that is formed on said one formation surface of the dielectric substrate where the strip conductor pattern is formed.

21. A directional coupler according to claim 5, wherein:
each of the primary line and the subsidiary line is provided by a strip conductor pattern that is formed in one formation surface of a dielectric substrate; and
said directional coupler comprises an ground conductor that is formed on said one formation surface of the dielectric substrate where the strip conductor pattern is formed.

22. A directional coupler comprising: a dielectric substrate having two formation surfaces; a primary line and a subsidiary line, which are formed on the dielectric substrate, and each of which has an input/output terminal for inputting/outputting a high frequency signal at both ends, and through which the high frequency signal propagates; and a coupled line in which the primary line is electromagnetically coupled to the subsidiary line; wherein as compared with electric field distribution in an odd mode in which the primary line and the subsidiary line are excited at out-of-phase equal amplitude, electric field distribution in an even mode, in which the primary line and the subsidiary line are excited at in-phase equal amplitude, concentrates on the inside of the dielectric substrate; said directional coupler comprising:
an inductive element that is mounted on the primary line and the subsidiary line, and that compensates for a series inductive component equivalently possessed by the coupled line.

23. A directional coupler according to claim 22, wherein:
the inductive element is an inductor that is provided between the input/output terminal and the coupled line.

24. A directional coupler according to claim 22, wherein:
the inductive element is a high impedance line that is provided between the input/output terminal and the coupled line.

25. A directional coupler according to claim 22, wherein:
each of the primary line and the subsidiary line is provided by a strip conductor pattern that is formed in one formation surface of a dielectric substrate; and
said directional coupler comprises an ground conductor that is formed on the other formation surface of the dielectric substrate, which is different from said one formation surface of the dielectric substrate where the strip conductor pattern is formed.

26. A directional coupler according to claim 23, wherein:
each of the primary line and the subsidiary line is provided by a strip conductor pattern that is formed in one formation surface of a dielectric substrate; and
said directional coupler comprises an ground conductor that is formed on the other formation surface of the dielectric substrate, which is different from said one formation surface of the dielectric substrate where the strip conductor pattern is formed.

27. A directional coupler according to claim 24, wherein:
each of the primary line and the subsidiary line is provided by a strip conductor pattern that is formed in one formation surface of a dielectric substrate; and
said directional coupler comprises an ground conductor that is formed on the other formation surface of the dielectric substrate, which is different from said one formation surface of the dielectric substrate where the strip conductor pattern is formed.
